(19) United States
(12) Patent Application Publication
(10) Pub. No.: US 2026/0214377 A1
(43) Pub. Date: Jul. 23, 2026

(54) SOUND-ABSORBING BLOCK, PREPARATION METHOD THEREOF, AND SOUND-PRODUCING APPARATUS

(71) Applicant: AAC Microtech (Changzhou) Co., Ltd., Changzhou City (CN)

(72) Inventors: Zhongyang Wang, Changzhou (CN); Hezhi Wang, Changzhou (CN); Jie Zhang, Changzhou (CN); Chao Wang, Changzhou (CN)

(21) Appl. No.: 19/336,467

(22) Filed: Sep. 22, 2025

Related U.S. Application Data
(63) Continuation of application No. PCT/CN2025/074058, filed on Jan. 22, 2025.

(51) Int. Cl. H04R 1/28; B32B 5/02; B32B 5/16; B32B 5/18; B32B 5/24; B32B 7/12; H04R 1/02

(52) U.S. Cl. CPC H04R 1/288; B32B 5/024; B32B 5/16; B32B 5/18; B32B 5/245; B32B 7/12; H04R 1/025; B32B 2250/05; B32B 2262/02; B32B 2262/062; B32B 2266/025; B32B 2266/06; B32B 2307/102; B32B 2307/724; B32B 2307/7376

(57) ABSTRACT

Provided is a sound-absorbing block, preparation method thereof and sound-producing apparatus. The sound-absorbing block includes at least two sound-absorbing layers and at least three air permeating layers. Air permeating layers and sound-absorbing layers are alternately stacked to form multilayer structure. Outermost layer of sound-absorbing block is one of air permeating layers. Adjacent sound-absorbing layer and air permeating layer are adhered and fixed by bonding process or thermal fusion process. Sound-absorbing layer is prepared by mixing sound-absorbing material powder, adhesive and thickening agent with mass ratio of 100:(1-10):(1-10). Air permeating layer is made of porous air permeating material. Compared with related art, the provided sound-absorbing block effectively solves problem of interior of sound-absorbing block being closed and incapable of air exchange, avoids a potential breaking risk of sound-absorbing block, effectively prolongs service life of sound-absorbing block and effectively improves sound-absorbing performance.

### TECHNICAL FIELD

The present disclosure relates to the technical field of sound-producing apparatuses and, in particular, to a sound-absorbing block, a preparation method thereof and a sound-producing apparatus.

### BACKGROUND

In the field of acoustics, in order to improve the audio quality of various mobile terminals, a common practice is to fill a rear cavity of a sound-producing apparatus with sound-absorbing materials to reduce a resonance frequency, so as to realize a physically large rear cavity volume.

In the related art, the sound-absorbing material commonly used in the small cavity is mainly a molecular sieve with a nano-scale microporous structure, and technically, the molecular sieve is usually formed into particles with a certain size and then packed in the rear cavity of the sound-producing apparatus to play a sound-absorbing role.

However, the sound-absorbing particles are subjected to phenomena, such as powder shedding and breaking, when colliding with each other, and meanwhile, the particles are difficult to pack due to static electricity during packing. Another related solution is to form zeolite into blocks, and no complicated granulation process is required. Such a solution has a simple process and can reduce a breaking risk caused by mutual collision of particles. However, the block has a large volume, and its strength is reduced. As a thickness is increased, the air permeability of the block is poor, and sound-absorbing powder in the block cannot play a sound-absorbing role, thus reducing the overall sound-absorbing efficiency of the block. When the block is applied to a rear cavity of a loudspeaker apparatus, the block is in direct contact with a hard inner wall of the cavity, and the block collides with and rubs against the inner wall and is quite prone to break and shed powder.

Therefore, it is desirable to provide a new sound-absorbing block to solve the above problems.

### SUMMARY

The present disclosure aims to provide a sound-absorbing block which has a good sound-absorbing performance and ease of application, a preparation method thereof and a sound-producing apparatus.

In order to solve the above technical problems, the present disclosure provides a sound-absorbing block, including at least two sound-absorbing layers and at least three air permeating layers. The air permeating layers and the sound-absorbing layers are alternately stacked to form a multilayer structure, an outermost layer of the sound-absorbing block is one of the air permeating layers, and adjacent sound-absorbing layer and air permeating layer are adhered and fixed by a bonding process or a thermal fusion process. The sound-absorbing layer is prepared by mixing a sound-absorbing material powder, an adhesives and a thickening agent with a mass ratio of 100:(1 to 10):(1 to 10). The air permeating layer is made of a porous air permeating material.

As an improvement, the air permeating layer has a thickness ranging from 0.1 mm to 2 mm, and the sound-absorbing layer has a thickness ranging from 0.1 mm to 5 mm.

As an improvement, the sound-absorbing layer has a thickness ranging from 0.1 mm to 2 mm.

As an improvement, the air permeating layer is heated and softened by the thermal fusion process and bonded to the sound-absorbing layer, with a thermal fusion temperature ranging from 100° C. to 200° C.

As an improvement, the air permeating layer is bounded to the sound-absorbing layer after being coated with a bonding agent, and the bonding agent is at least one of a polyacrylate adhesive, an epoxy resin adhesive, a polyurethane adhesive and a silicone adhesive.

As an improvement, the sound-absorbing material powder is a zeolite material, the zeolite material is at least one of zeolite socony mobil-5 (MFI), zeolite socony mobil-11 (MEL) and ferrierite (FER), and a particle size of the zeolite material is less than 10 μm.

As an improvement, the adhesive is at least one of polyacrylate, polystyrene acrylate, polystyrene acetate and polyethylene vinyl acetate salt.

As an improvement, the thickening agent is at least one of sodium alginate, sodium carboxymethyl cellulose and polyvinyl alcohol.

As an improvement, the porous air permeating material is at least one of melamine foam, polyurethane foam, ethylene-vinyl acetate (EVA) foam and ethylene-propylene-diene monomer (EPDM) foam with an open-cell structure.

As an improvement, the porous air permeating material is prepared by interweaving fiber filaments having an interconnected structure, and the fiber filaments are at least one of cotton fibers, polyester fibers, polyethylene fibers and polyacrylonitrile fibers.

The present disclosure further provides a method for preparing the above sound-absorbing block, including following steps: mixing a sound-absorbing material powder, an adhesive, a thickening agent and water with a mass ratio of 100:(1 to 10):(1 to 10):(80 to 200) to obtain a sound-absorbing material slurry; preparing a sound-absorbing layer from the sound-absorbing material slurry by a low-temperature drying process; and alternately stacking at least three prepared air permeating layers and at least two prepared sound-absorbing layers to form a multilayer structure with an outermost layer after stacking being the air permeating layer, and attaching and fixing the air permeating layer and the sound-absorbing layer adjacent to each other by a bonding process or a thermal fusion process to obtain the sound-absorbing block.

The present disclosure further provides a sound-producing apparatus, including a housing with a receiving space, and a sound-producing unit received in the receiving space. A rear cavity is surrounded by the sound-producing unit and the housing, and the rear cavity is filled with the above sound-absorbing block.

As an improvement, an outermost air permeating layer of the sound-absorbing block is in contact with an inner wall of the rear cavity, and the sound-absorbing block is fixed in the rear cavity by being pressed by an inner wall of the housing.

Compared with the related art, the sound-absorbing block according to the present disclosure incudes a sound-absorbing layer and an air permeating layer. The sound-absorbing block includes at least two sound-absorbing layers and at least three air permeating layers, the air permeating layers and the sound-absorbing layers are alternately stacked to form the multilayer structure, the outermost layer of the sound-absorbing block is one of the air permeating layers, and adjacent sound-absorbing layer and air permeating layer are adhered and fixed by the bonding process or thermal fusion process. The sound-absorbing layer is prepared by mixing the sound-absorbing material powder, the adhesive and the thickening agent with the mass ratio of 100:(1 to 10):(1 to 10). The air permeating layer is made of the porous air permeating material. The sound-absorbing layers are distributed inside the sound-absorbing block and on a surface thereof, and at least one air permeating layer may exist inside the sound-absorbing block, which effectively solves the problem of the interior of the sound-absorbing block being closed and incapable of air exchange. The air permeating layer and the sound-absorbing layer are bonded together by bonding or thermal fusion, thereby improving an integral cavity of the sound-absorbing block, and effectively avoiding a potential breaking risk of the sound-absorbing block. When the sound-absorbing block is packed in the cavity of the sound-producing apparatus, the surface air permeating layer provides the sound-absorbing block with an air exchange layer and a protective layer, thereby effectively prolonging the service life of the sound-absorbing block and effectively improving the sound-absorbing performance thereof.

### BRIEF DESCRIPTION OF DRAWINGS

To better describe the technical solutions in embodiments of the present disclosure, the following briefly describes the drawings required for the description of the embodiments. It is appreciated that the drawings in the following description show merely some embodiments of the present disclosure, and a person of ordinary skill in the art may still derive other drawings from these drawings without creative efforts. In the drawings:

FIG. 1 is a schematic structural diagram of a sound-absorbing block according to an embodiment of the present disclosure;

FIG. 2 is a schematic structural diagram of a sound-absorbing block with multiple air permeating layers in the middle according to an embodiment of the present disclosure;

FIG. 3 is a schematic structural diagram of a sound-absorbing block as a comparative example according to an embodiment of the present disclosure; and

FIG. 4 is a schematic structural diagram of a sound-producing apparatus according to an embodiment of the present disclosure.

### DESCRIPTION OF EMBODIMENTS

The technical solutions in the embodiments of the present disclosure are clearly and completely described with reference to the drawings in the embodiments of the present disclosure. It is appreciated that the described embodiments are not all but only a part of the embodiments of the present disclosure. All other embodiments obtained by a person of ordinary skill in the art based on the embodiments of the present disclosure without creative efforts shall fall within the protection scope of the present disclosure.

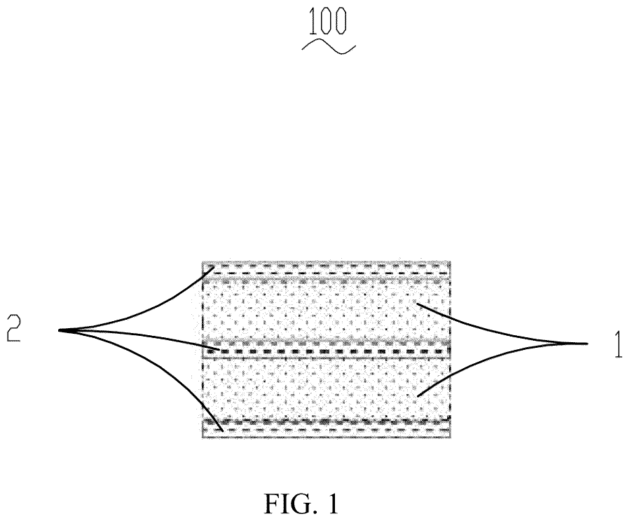

Referring to FIG. 1, an embodiment of the present disclosure provides a sound-absorbing block 100, including at least two sound-absorbing layers 1 and at least three air permeating layers 2. The sound-absorbing block 100 shown in FIG. 1 includes two sound-absorbing layers 1 and three air permeating layers 2. The air permeating layers 2 and the sound-absorbing layers 1 are alternately stacked to form a multilayer structure. An outermost layer of the sound-absorbing block 100 is one of the air permeating layers 2. The adjacent sound-absorbing layer 1 and air permeating layer 2 are adhered and fixed by a bonding process or a thermal fusion process.

The sound-absorbing layer 1 is prepared by mixing a sound-absorbing material powder, an adhesive and a thickening agent with a mass ratio of 100:(1 to 10):(1 to 10). The sound-absorbing layer 1 plays the role of adsorbing and desorbing air, which can effectively reduce the resonance frequency of a sound-producing apparatus to play a sound-absorbing role. The sound-absorbing layer 1 is a functional unit of the sound-absorbing block 100.

The air permeating layer 2 is made of a porous air permeating material. The air permeating layer 2 plays the role of air permeating and sound absorption. The air permeating layer 2 is soft and elastic, which can enhance the stability of the sound-absorbing block 100 to prevent the sound-absorbing block 100 from being broken.

The air permeating layer 2 covering the outside of the sound-absorbing block 100 can also prevent the sound-absorbing block 100 from colliding with other components of the sound-producing apparatus and causing powder shedding.

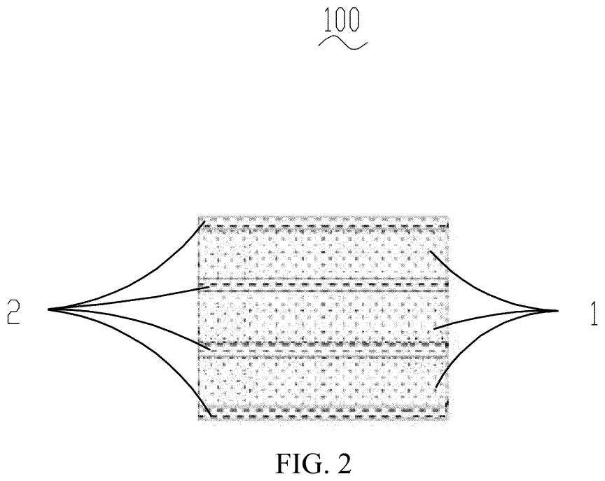

Further, referring to FIG. 2, the sound-absorbing block 100 is shown having a structure in which the middle includes two air permeating layers 2 and a total of four air permeating layers 2 are included in the block. The air permeating layers 2 in the middle of the sound-absorbing block 100 increase contact areas between sound-absorbing particles inside the sound-absorbing block 100 and the air, and enhance an air exchange of the sound-absorbing block 100, thus improving the sound-absorbing performance of the sound-absorbing block 100. The porous structure of the air permeating layer 2 also has a certain sound-absorbing effect, thus further improving the acoustic performance of the sound-absorbing block 100.

In order to reduce a space occupied by a cavity of the sound-producing apparatus as much as possible and ensure that the sound-absorbing block 100 has a good acoustic performance, the air permeating layer 2 has a thickness ranging from 0.1 mm to 2 mm, and the sound-absorbing layer has a thickness ranging from 0.1 mm to 5 mm. For the multilayer structure shown in FIG. 2, the number of layers and the specific thickness of the sound-absorbing block 100 can be adjusted according to the actual performance of the specific sound-producing apparatus. In some embodiments, when the number of the air permeating layers 2 inside the sound-absorbing block 100 is sufficient, the thickness of the sound-absorbing layer 1 is further reduced to 0.1 mm to 2 mm.

In some embodiments, the air permeating layer 2 is heated and softened by the thermal fusion process and bonded to the sound-absorbing layer 1, with a thermal fusion temperature ranging from 100° C. to 200° C.

In some embodiments, the air permeating layer 2 is bounded to the sound-absorbing layer 1 after being coated with a bonding agent. The bonding agent is at least one of a polyacrylate adhesive, an epoxy resin adhesive, a polyurethane adhesive and a silicone adhesive.

In some embodiments, the sound-absorbing material powder is a zeolite material, the zeolite material is at least one of MFI, MEL and FER, and a particle size of the zeolite material is less than 10 μm.

In some embodiments, the adhesive is at least one of polyacrylate, polystyrene acrylate, polystyrene acetate and polyethylene vinyl acetate salt.

In some embodiments, the thickening agent is at least one of sodium alginate, sodium carboxymethyl cellulose and polyvinyl alcohol.

In some embodiments, the porous air permeating material is at least one of melamine foam, polyurethane foam, EVA foam and EPDM foam with an open-cell structure.

In some embodiments, the porous air permeating material is prepared by interweaving fiber filaments having an interconnected structure, and the fiber filaments are at least one of cotton fibers, polyester fibers, polyethylene fibers and polyacrylonitrile fibers.

An embodiment of the present disclosure further provides a method for preparing the sound-absorbing block 100 according to the above embodiments, including the following steps.

A sound-absorbing material powder, an adhesive, a thickening agent and water are mixed with a mass ratio of 100:(1 to 10):(1 to 10):(80 to 200) to obtain a sound-absorbing material slurry.

A sound-absorbing layer 1 is prepared from the sound-absorbing material slurry by a low-temperature drying process.

At least three prepared air permeating layers 2 and at least two prepared sound-absorbing layers 1 are alternately stacked to form a multilayer structure with an outermost layer after stacking being the air permeating layer 2, and the adjacent air permeating layer 2 and the sound-absorbing layer 1 are adhered and fixed by a bonding process or a thermal fusion process to obtain the sound-absorbing block 100.

For example, based on the method for preparing the sound-absorbing block 100 according to the embodiments of the present disclosure, and referring to the materials in the above embodiments, the present disclosure provides the following two available preparation processes.
Method I: the sound-absorbing material powder, polyacrylate adhesive, sodium alginate and water are uniformly mixed with a mass ratio of 100:10:2:100 to obtain a sound-absorbing material slurry, and the slurry is molded into a certain thickness. A sound-absorbing layer 1 with a thickness of 2 mm is obtained by a low-temperature drying process. The sound-absorbing layers 1 and a melamine foam with a thickness of 0.2 mm are stacked into the structure as shown in FIG. 1, and air permeating layers 2 formed by thermal fusion and softening at 160° C. are added to adhere to the sound-absorbing layers 1, so as to obtain the sound-absorbing block 100.
Method II: the sound-absorbing material powder, polyacrylate adhesive, sodium alginate and water are uniformly mixed with a mass ratio of 100:10:2:100 to obtain a sound-absorbing material slurry, and the slurry is molded into a certain thickness. A sound-absorbing layer 1 with a thickness of 2 mm is obtained by a low-temperature drying process. The sound-absorbing layers 1 and a cotton fiber layer with a thickness of 0.1 mm are stacked into the structure as shown in FIG. 2, and a acrylic adhesive is added to attach and fix the sound-absorbing layers 1 and the air permeating layers 2, so as to obtain the sound-absorbing block 100.

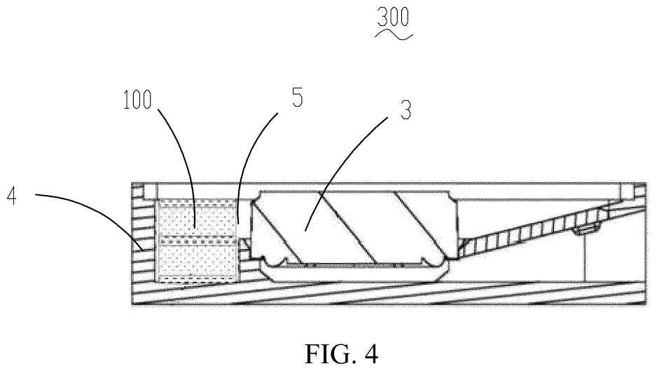

An embodiment of the present disclosure further provides a sound-producing apparatus 300, as shown in FIG. 4. The sound-producing apparatus 300 includes a housing 4 with a receiving space, and a sound-producing unit 3 received in the receiving space. A rear cavity 5 is surrounded by the sound-producing unit 3 and the housing 4. The rear cavity 5 is filled with the above sound-absorbing block (in FIG. 4, the sound-absorbing block 100 shown in FIG. 1 is taken as an example).

In some embodiments, the outermost air permeating layer 2 of the sound-absorbing block 100 is in contact with an inner wall of the rear cavity 5, and the sound-absorbing block 100 is fixed in the rear cavity 5 by being pressed by an inner wall of the housing 4.

In the embodiment of the present disclosure, the sound-producing apparatus 300 and the sound-absorbing blocks 100 with different structures prepared from different raw materials were subjected to an acoustic performance test and a drop test, the test cavity was 1 cc, the sound-absorbing blocks 100 were packed in the rear cavity 5 of the sound-producing apparatus 400, and subjected to a free-drop test from a height of 1 m for 50 cycles. The sound-absorbing block 100 prepared by the preparation method I was placed in a cavity with a thickness of 4.5 mm, and when the sound-producing apparatus 400 was assembled, the sound-absorbing block 100 was fixed in the rear cavity 5 under the pressing action of the housing 4. The sound-absorbing block 100 prepared by the preparation method II was placed in a cavity with a thickness of 3.2 mm.

Meanwhile, the present disclosure further provides a sound-absorbing block 200 as a comparative example, and the preparation method is as follows.

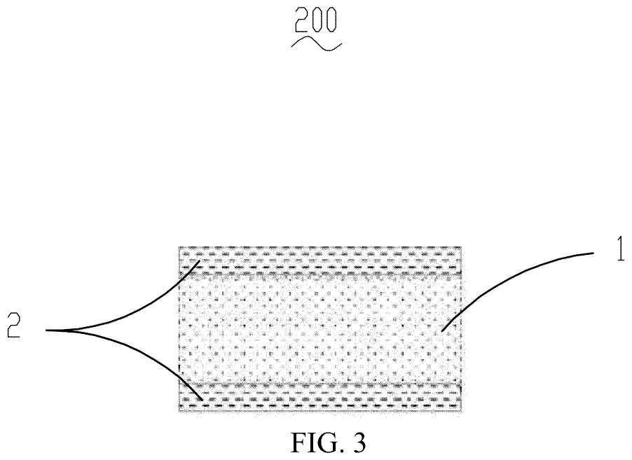

The sound-absorbing material powder, polyacrylate adhesive, sodium alginate and water are uniformly mixed with a mass ratio of 100:10:2:100 to obtain a sound-absorbing material slurry, and the slurry is molded into a certain thickness. A sound-absorbing layer 1 with a thickness of 4 mm is obtained by a low-temperature drying process. The sound-absorbing layers 1 and the melamine foam with a thickness of 0.2 mm are stacked into the structure as shown in FIG. 3, and air permeating layers 2 formed by thermal fusion and softening at 160° C. are added to adhere to the sound-absorbing layers 1, so as to obtain a sound-absorbing block 200. The sound-absorbing block 200 is placed into a cavity with a thickness of 4.2 mm.

The test results are shown in Table 1 below.

TABLE 1
Acoustic and drop test results of sound-absorbing block

| | Performance | |
|---|---|---|
| Sample | ΔF0/Hz | Drop test |
| Method I | 182 | No change |
| Method II | 198 | No change |
| Comparative example | 154 | Broken |

It can be seen that different air permeating and sound-absorbing effects can be achieved by combining different numbers of air permeating layers and sound-absorbing layers. The acoustic performance of the sound-absorbing block prepared by the method II (FIG. 2) is superior to that of the method I (FIG. 1). This is because there are two air permeating layers inside the block, which makes the air permeability of the block better and allows the sound-absorbing powder to fully perform its functions, resulting in better performance. Compared with the comparative example (FIG. 3), the sound-absorbing blocks prepared by different methods in the embodiments of the present disclosure are superior to those in the comparative example in terms of performance and strength, and the multilayer sound-absorbing block according to the present disclosure has a simple preparation process and low cost.

Compared with the related art, the sound-absorbing block according to the present disclosure incudes a sound-absorbing layer and an air permeating layer. The sound-absorbing block includes at least two sound-absorbing layers and at least three air permeating layers, the air permeating layers and the sound-absorbing layers are alternately stacked to form the multilayer structure, the outermost layer of the sound-absorbing block is one of the air permeating layers, and adjacent sound-absorbing layer and air permeating layer are adhered and fixed by the bonding process or thermal fusion process. The sound-absorbing layer is prepared by mixing the sound-absorbing material powder, the adhesive and the thickening agent with the mass ratio of 100:(1 to 10):(1 to 10). The air permeating layer is made of the porous air permeating material. The sound-absorbing layers are distributed inside the sound-absorbing block and on a surface thereof, and at least one air permeating layer may exist inside the sound-absorbing block, which effectively solves the problem of the interior of the sound-absorbing block being closed and incapable of air exchange. The air permeating layer and the sound-absorbing layer are bonded together by bonding or thermal fusion, thereby improving an integral cavity of the sound-absorbing block, and effectively avoiding a potential breaking risk of the sound-absorbing block. When the sound-absorbing block is packed in the cavity of the sound-producing apparatus, the surface air permeating layer provides the sound-absorbing block with an air exchange layer and a protective layer, thereby effectively prolonging the service life of the sound-absorbing block and effectively improving the sound-absorbing performance thereof.

The above description is only embodiments of the present disclosure. It should be noted that improvements can be made by those of ordinary skill in the art without departing from the concept of the present disclosure, and all fall within the protection scope of the present disclosure.

What is claimed is:

1. A sound-absorbing block, comprising at least two sound-absorbing layers and at least three air permeating layers, wherein the air permeating layers and the sound-absorbing layers are alternately stacked to form a multilayer structure, an outermost layer of the sound-absorbing block is one of the air permeating layers, and adjacent sound-absorbing layer and air permeating layer are adhered and fixed by a bonding process or a thermal fusion process;
the sound-absorbing layer is prepared by mixing a sound-absorbing material powder, an adhesive and a thickening agent with a mass ratio of 100:(1 to 10):(1 to 10); and
the air permeating layer is made of a porous air permeating material.

2. The sound-absorbing block as described in claim 1, wherein the air permeating layer has a thickness ranging from 0.1 mm to 2 mm, and the sound-absorbing layer has a thickness ranging from 0.1 mm to 5 mm.

3. The sound-absorbing block as described in claim 2, wherein the sound-absorbing layer has a thickness ranging from 0.1 mm to 2 mm.

4. The sound-absorbing block as described in claim 1, wherein the air permeating layer is heated and softened by the thermal fusion process and bonded to the sound-absorbing layer, with a thermal fusion temperature ranging from 100° C. to 200° C.

5. The sound-absorbing block as described in claim 1, wherein the air permeating layer is bounded to the sound-absorbing layer after being coated with a bonding agent, and the bonding agent is at least one of a polyacrylate adhesive, an epoxy resin adhesive, a polyurethane adhesive and a silicone adhesive.

6. The sound-absorbing block as described in claim 1, wherein the sound-absorbing material powder is a zeolite material, the zeolite material is at least one of zeolite socony mobil-5 (MFI), zeolite socony mobil-11 (MEL) and ferrierite (FER), and a particle size of the zeolite material is less than 10 μm.

7. The sound-absorbing block as described in claim 1, wherein the adhesive is at least one of polyacrylate, polystyrene acrylate, polystyrene acetate and polyethylene vinyl acetate salt.

8. The sound-absorbing block as described in claim 1, wherein the thickening agent is at least one of sodium alginate, sodium carboxymethyl cellulose and polyvinyl alcohol.

9. The sound-absorbing block as described in claim 4, wherein the porous air permeating material is at least one of melamine foam, polyurethane foam, ethylene-vinyl acetate (EVA) foam and ethylene-propylene-diene monomer (EPDM) foam with an open-cell structure.

10. The sound-absorbing block as described in claim 5, wherein the porous air permeating material is prepared by interweaving fiber filaments having an interconnected structure, and the fiber filaments are at least one of cotton fibers, polyester fibers, polyethylene fibers and polyacrylonitrile fibers.

11. A method for preparing the sound-absorbing block as described in claim 1, comprising following steps:
mixing a sound-absorbing material powder, an adhesive, a thickening agent and water with a mass ratio of 100:(1 to 10):(1 to 10):(80 to 200) to obtain a sound-absorbing material slurry;
preparing a sound-absorbing layer from the sound-absorbing material slurry by a low-temperature drying process; and
alternately stacking at least three prepared air permeating layers and at least two prepared sound-absorbing layers to form a multilayer structure with an outermost layer after stacking being the air permeating layer, and attaching and fixing the air permeating layer and the sound-absorbing layer adjacent to each other by a bonding process or a thermal fusion process to obtain the sound-absorbing block.

12. A sound-producing apparatus, comprising a housing with a receiving space, and a sound-producing unit received in the receiving space, wherein a rear cavity is surrounded by the sound-producing unit and the housing, and the rear cavity is filled with the sound-absorbing block as described in claim 1.

13. The sound-producing apparatus as described in claim 12, wherein an outermost air permeating layer of the sound-absorbing block is in contact with an inner wall of the rear cavity, and the sound-absorbing block is fixed in the rear cavity by being pressed by an inner wall of the housing.
